(19) United States
(12) Patent Application Publication
(10) Pub. No.: US 2021/0019428 A1
(43) Pub. Date: Jan. 21, 2021

(54) PRESERVATION SYSTEM FOR PRESERVING PRIVACY OF OUTSOURCED DATA IN CLOUD BASED ON DEEP CONVOLUTIONAL NEURAL NETWORK

(71) Applicant: Fuzhou University, Fuzhou City (CN)

(72) Inventors: Ximeng Liu, Fuzhou City (CN); Wenzhong Gou, Fuzhou City (CN); Jiayin Li, Fuzhou City (CN); Hongrui Lin, Fuzhou City (CN); Yang Yang, Fuzhou City (CN)

(73) Assignee: Fuzhou University, Fuzhou City (CN)

(21) Appl. No.: 16/930,943

(22) Filed: Jul. 16, 2020

(30) Foreign Application Priority Data
Jul. 19, 2019 (CN) 201910653448. 6

(51) Int. Cl. G06F 21/60; H04L 9/08; H04L 9/00; G06N 3/04; G06N 3/08

(52) U.S. Cl. CPC G06F 21/602; H04L 9/083; G06N 3/08; G06N 3/04; H04L 9/008

(57) ABSTRACT

The present invention relates to a preservation system for preserving privacy of outsourced data in a cloud based on a deep convolutional neural network (CNN). The system includes a key generation center, a cloud platform, a data user, and a CNN service providing unit. The key generation center is an entity trusted by all other entities in the system, and is responsible for distributing and managing all keys of a data user or a CNN service provider, and all boot keys of the cloud platform. The cloud platform stores and manages encrypted data outsourced from a registrant in the system, and provides a computing capability to perform a homomorphic operation on the encrypted data. The CNN service provider provides a required deep classification model for the data user, and a decision result reflects a current situation of the data user.

### TECHNICAL FIELD

The present invention relates to a preservation system for preserving privacy of outsourced data in a cloud based on a deep convolutional neural network (CNN) called POCNet.

### BACKGROUND

As our daily lives (such as cloud computing and intelligent wearable devices) become more digitized, digital devices have created more data. For example, it is estimated that a data quantity is expected to reach 40 ZB by 2020, that is, 5247 GB per person. However, a study conducted by the International Data Corporation (IDC) shows that only a small percentage (3%) of existing digital data is currently marked and available, and only 0.5% of the existing data is used for analysis, which, to a certain extent, leads to growing attention and investment in big data analysis and other data mining technologies.

A CNN is a deep artificial neural network and a popular data mining technology that has been applied to many fields, such as image recognition, video analysis, natural language processing, and games. The CNN allows for performing semi-automated or automated analysis on a large quantity of data to minimize human intervention.

However, an actual situation is taken into consideration when a CNN classifier or any other classifier is used. For example, a patient may hope to store his/her personal medical image in a cloud. However, how do we ensure security of personal data of the patient? In addition, medical service providers may also hope to use cloud servers to store classifiers they use. Since a classifier may be a property of a specific medical service provider, how do we ensure that the classifier is preserved from unauthorized disclosure? Data encryption is a potential solution, which brings another challenge. How do we execute a CNN classifier in an encrypted domain?

To support CNN in performing a classification task and another analysis task on outsourced data, a cloud server needs to support some basic commonly used arithmetic operations (such as a comparison operation and a multiplication operation). Since data is stored as ciphertexts in a cloud, these essential arithmetic operations need to be performed on encrypted data without compromising privacy of original data. In an outsourcing cloud environment, there are many frameworks designed for processing encrypted data. However, on the existing framework, an additional server is usually required to provide a decryption capability required for secure computations, or multi-round communications are performed between a user and the cloud. In this case, a data leakage risk or energy/electricity consumption of a customer is increased.

### SUMMARY

In view of this, an objective of the present invention is to provide a preservation system for preserving privacy of outsourced data in a cloud based on a deep CNN, to securely calculate and classify data without privacy leakage.

To achieve the above objective, the present invention uses the following technical solutions.

A preservation system for preserving privacy of outsourced data in a cloud based on a deep CNN is provided, where the system includes a key generation center, a cloud platform, a data user, and a CNN service providing unit; the key generation center is an entity trusted by all other entities in the system, and is responsible for distributing and managing all keys of a data user or a CNN service provider, and all boot keys of the cloud platform; the cloud platform stores and manages encrypted data outsourced from a registrant in the system, and provides a computing capability to perform a homomorphic operation on the encrypted data; the CNN service provider provides a required deep CNN classification model for the data user, and a decision result reflects a current situation of the data user.

The preservation method for preserving privacy of outsourced data in a cloud based on a deep CNN includes the following steps:

Step S1: the data user transfers the encrypted data to the CNN service providing unit by using the cloud platform; and

Step S2: after processing the encrypted data, the CNN service providing unit outputs a ciphertext result and stores the ciphertext result on the cloud platform.

Further, step S2 is specifically as follows:

Step S21: convert a format of the encrypted data, to obtain converted encrypted data;

Step S22: process the converted encrypted data sequentially by using a convolutional layer, a pooling layer, and an ReLU function of the CNN; and

Step S23: execute full connection calculation and activation function calculation of the CNN, and outputting the ciphertext result.

Further, the format conversion includes secure data transformation, secure ciphertext length control, and unified conversion of secure data.

Further, the convolutional layer specifically inputs d₁ encrypted matrixes \hat{X}ᵢ and a matrix Û_{i,j} having a size of d₁×d₂, the convolutional layer outputs d₂ encrypted matrixes Ŷⱼ, and an architecture is as follows:

(1) initializing each element in Ŷⱼ by encrypting 0; and

(2) for i=0, . . . ,d₁−1,j=0, . . . ,d₂1, calculating \hat{X}′_{i,j}←F.conv(\hat{X}ᵢ, Û_{i,j}) and Ŷ′ⱼ←F.madd(Ŷⱼ,\hat{X}′_{i,j}).

Further, the pooling layer specifically inputs a w₁×w₁ encrypted matrix \hat{X} and obtains output, that is, a w₂×w₂ encrypted matrix Ŷ, and performs the following steps: for 0≤i≤w₂−1 and 0≤j≤w₂1.
(i) constructing each encrypted matrix Ĉ_{i,j} having a size of t×t, where for ĉ_{i,j,a,b}=\hat{x}_{ei+a,ej+b}, 0≤a≤t−1,0≤b≤t−1, and e is a step;
(ii) executing ŷ_{i,j}←F.pool(Ĉ_{i,j}), where after the calculation is performed, ŷ_{i,j} is used as an element of Ŷ.

Further, for the ReLU function, a t×t encrypted matrix \hat{X} is specifically given, and a goal of an SReLU is to produce a t×t encrypted matrix Ŷ, such that

msg(ŷ_{i,j})←ReLU(msg(\hat{x}_{i,j}))=max(0,msg(\hat{x}_{i,j})).

Further, the full connection calculation of the CNN is specifically as follows:

inputting encrypted vectors \hat{X}=(\hat{x}₀, . . . ,\hat{x}ₐ₋₁) and Ŷᵢ=(ŷ_{i,0}, . . . ,ŷ_{i,a-1})(0≤i≤b−1), and outputting, by a secure fully connected layer, \hat{N}=(\hat{n}₀, . . . ,\hat{n}_{b-1}), where

$$msg ( {\hat{n}}_{i} ) = {\sum }_{j = 0}^{n - 1} msg ( {\hat{x}}_{j} ) \cdot msg ( {\hat{y}}_{i , j} ) ;$$

and for i=0, . . . ,b−1, calculating \hat{n}ᵢ←F.inp(\hat{X},Ŷᵢ).

Further, the activation function calculation of the CNN is specifically as follows: giving t encrypted tuples (\hat{x}₀,\hat{d}₀), . . . ,(\hat{x}ₜ₋₁,\hat{d}ₜ₋₁); and finally outputting, by an SSOFT, an encrypted identity \hat{d}*. Construction is performed as follows:

(1) pᵢ is inserted into Θ, where S(Θ) denotes a size of the set Θ; and

(2) this process is similar to an F.pool architecture, except that F.maxe is replaced with F.maxt.

After the calculation is completed, only one tuple (\hat{x}*,\hat{d}*₀) is left in Θ, and the encrypted identity that is finally output is denoted as \hat{d}*=\hat{d}*₀.

Compared with the prior art, the present invention has the following beneficial effects:

Based on the present invention, a secure storage system is designed. The system may perform a classification operation of the deep CNN in real time and efficiently without using an additional (non-collusion) server, such that data is securely calculated and classified without privacy leakage.

### BRIEF DESCRIPTION OF THE DRAWINGS

FIG. 1 is a schematic diagram of a system according to the present invention; and

FIG. 2 is a system architectural diagram of a CNN according to the present invention.

### DETAILED DESCRIPTION

The present invention is described in more detail with reference to the accompanying drawings and examples.

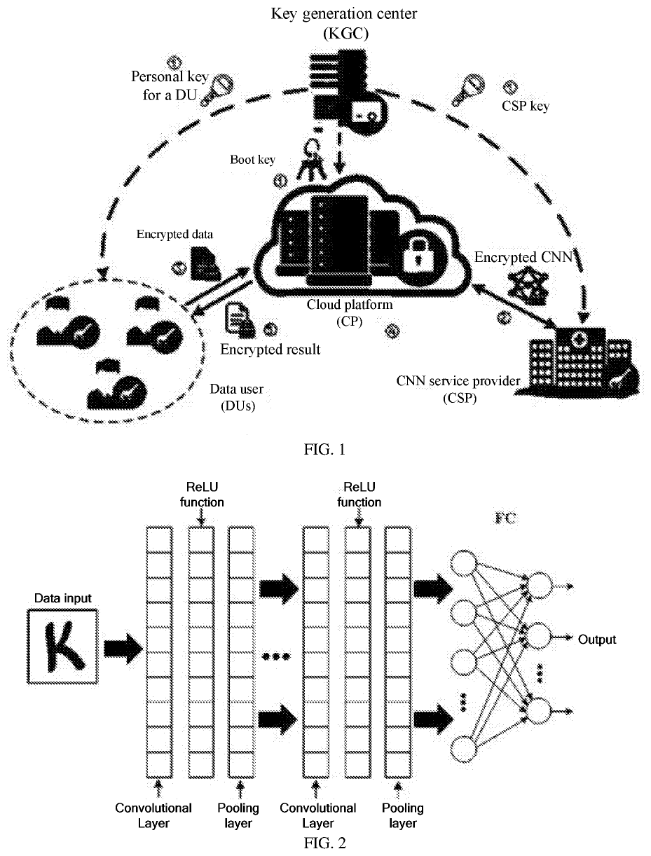

Referring to FIG. 1, the present invention provides a preservation system for preserving privacy of outsourced data in a cloud based on a deep CNN. The system includes a key generation center, a cloud platform, a data user, and a CNN service providing unit. The key generation center is an entity trusted by all other entities in the system and is responsible for distributing and managing all keys of a data user or a CNN service provider, and all boot keys of the cloud platform. The cloud platform stores and manages encrypted data outsourced from a registrant in the system and provides a computing capability to perform a homomorphic operation on the encrypted data. The CNN service provider provides a required deep CNN classification model for the data user, and a decision result reflects a current situation of the data user.

In this example, a basic safety unsigned/signed integer circuit is created, and the safety integer circuit is implemented in a plurality of encrypted domains. Details are as follows:

### 1. Initialize the System.

First, a Fully Homomorphic Encryption Scheme over Tours (TFHE) whose plaintext space is T₈ used as a basis, −⅛ and ⅛ in a binary circuit architecture respectively denote 0 and 1. Then boot parameters μ₀=−⅛ and μ₁=⅛ are set. One μ-bit unsigned integer a may be denoted as (a_{μ-1},a_{μ-2}, . . . ,a₀). To store a through encryption, each bit may be encrypted by using the TFHE, to obtain ã=(a_{μ-1},a_{μ-2}, . . . ,a₀)=(κ(a_{μ-1}), . . . ,κ(a₀)). ã is used to denote a μ−length ciphertext.

### 2. Basic Secure Unsigned Integer Circuit

Some basic secure unsigned integers are to be constructed by using the TFHE ciphertext.

First, a secure full adder circuit (Badd) is designed: Three encrypted bits κ(a),κ(b), and κ(cₙ) are given, and a secure full adder outputs two encrypted bits κ(o) and κ(cₜ). Therefore, o=a⊕b⊕cₙ and cₜ=(aΛb)⊕(cₙΛ(a⊕b)), where o is a bit addition result, and cₜ is denoted as bit carry-out. A procedure for constructing Badd is as follows:

(1) Calculate λ₁←Hand(κ(a),κ(b)),λ₂←Hxor(κ(a),κ(b)), and

λ₃←Hand(λ₂,κ(cₙ)).

(2) Calculate κ(o)←Hxor(λ₂,κ(cₙ)) and κ(cₜ)←Hxor(λ₁,λ₃). Herein, the secure full adder is denoted as (κ(o),κ(cₜ))←Badd(κ(a),κ(b),κ(cₒ)).

A secure signed integer addition circuit (UI.add) is designed: Two μ−length ciphertexts ã=(κ(a_{μ-1}),κ(a_{μ-2}), . . . ,κ(a₀)) and \tilde{b}=(κ(b_{μ-1}),κ(b_{μ-2}), . . . ,κ(b₀)) are given, and a secure unsigned integer addition may securely output a (μ+1)−length ciphertext ñ=(κ(n_{μ}),κ(n_{μ-2}), . . . ,κ(n₀)). Therefore, msg(ñ)=msg(ã)+msg(\tilde{b}). The secure signed integer addition circuit has a simple and intuitive idea: Since Badd can be considered as a bit addition with carry-out, Ui.add is directly constructed by using Badd, and details are as follows:

(1) Initialize κ(c₀), such that, c₀=0.

(2) For i=0, . . . , μ−1, calculate (κ(nᵢ),κ(cᵢ₊₁))←Badd(κ(aᵢ),κ(bᵢ),κ(cᵢ)). After calculation is performed based on the foregoing formula, it is set that κ(n_{μ})←κ(c_{μ}) and the circuit is denoted as ñ←UI.add(ã,\tilde{b}).

Then, a preservation unsigned integer comparison circuit (UI.cmp) is designed:

Two μ−length ciphertexts ã=(κ(a_{μ-1}),κ(a_{μ-2}), . . . ,κ(a₀)) and \tilde{b}=(κ(b_{μ-1}),κ(b_{μ-2}), . . . ,κ(b₀)) are given, and UI.cmp securely outputs an encrypted bit k(t). If msg(ã)≥msg(\tilde{b}), t=0. If msg(ã)≤msg(\tilde{b}),t=1. A final result is defined as msg(ã) and msg(\tilde{b}). A first different bit from high-order to low-order may be constructed as follows:

(1) Calculate κ(t₀)←Hand(Hnot(κ(a₀)),(κ(b₀)).

(2) For i=0, . . . , μ−1, calculate

κ(cᵢ)←Hand(Hnot(κ(aᵢ)),κ(bᵢ));

κ(c′ᵢ)←Hand(Hnot(κ(aᵢ),κ(bᵢ)),κ(tᵢ));

κ(tᵢ+1)←Hxor(κ(cᵢ),κ(c′ᵢ)).

In the foregoing formula, it is set that κ(t)←κ(tᵢ₊₁), and the circuit is denoted as κ(t)←UI.cmp(ã,\tilde{b}).

Finally, a secure unsigned integer multiplication circuit (UI.mul) is designed: Two μ−length ciphertexts ã and \tilde{b} are given, and a 2μ−length ciphertext ñ is obtained as a final multiplication result.

Step 1: first, for i=0 to μ−1, recurrently execute the following equations:

(1) for j=1, . . . ,μ−1+i, calculating κ(c′_{i,j})←Hand(κ(aⱼ₋ᵢ),κ(bᵢ));

(2) constructing an i-th encrypted vector as \tilde{c}′ᵢ=(κ(c′_{i,i+μ-1}), . . . ,κ(c′_{i,0})), where for i>0,c′_{i,0}=. . . =c′_{i,i+1}=0.

Step 2: add integers [symbol] ᵢ, . . . [symbol] _{μ-1} together by using UI.add, in other words, it is denoted that ñ→ [symbol] ₀ and κ(n_{μ})=κ(0); then, for i=1, . . . , μ−1, calculate ñ←UI. add(ã, [symbol] ᵢ), where the circuit is denoted as ñ←UI.mul(ã,\tilde{b}), and 2μ−length ñ is finally output, because the length of ñ is increased by 1 when UI.add is executed.

### 3. Secure Signed Integer Storage and Computation

Herein, it is explained how to securely store a signed integer, and a basic signed integer operation is described.

First, a two's complement is represented, and a two's complement number system encodes positive and negative numbers into a binary number representation. A weight of each bit is a power of 2, except the most significant bit whose weight is a negative value of a power of a corresponding bit 2. An (integer) value of a μ-bit integer a=(a_{μ-1},a_{μ-2}, . . . ,a₀) is denoted by using the following formula:

$$dsg ( a ) = - {a}_{μ - 1} {2}^{μ - 1} + {\sum }_{i = 0}^{μ - 2} {a}_{j} {2}^{i} ,$$

where dsg(·) denotes a decimal value of a binary vector. A two's complement number system may be used to denote all integers from −2^{μ-1} to 2^{μ-1}. (a_{μ-1},a_{μ-2}, . . . ,a₀) is given, (1⊕a_{μ-1},1⊕a_{μ-2}, . . . ,1⊕a₀) is executed for the first time, and then a decimal integer (0, . . . ,0,1) is added. After conversion is completed, the TFHE encrypts them bit by bit, and a μ−length ciphertext is sent to a cloud for outsourced storage. Then how to securely implement basic secure signed integer computation is demonstrated.

Second, a secure signed integer equality test circuit (I.equ) is designed: Two ciphertexts ã=(κ(a_{μ-1}),κ(a_{μ-2}), . . . ,κ(a₀)) and \tilde{b}=(κ(b_{μ-1}),κ(b_{μ-2}), . . . ,κ(b₀)) having a length of μ bits and storing signed integers msg(ã) and msg(\tilde{b}) are given, and I.eq can securely output an SLWE instance κ(t). If msg(ã)=msg(\tilde{b}), t=1. If msg(ã)≠msg(\tilde{b}), t=0. A high-level idea is to compare the two integers bit by bit. If all bits are the same, the two integers are equal. An implementation procedure is as follows:

(1) Initialize κ(t)←Hxor(κ(a₀),κ(b₀)).

(2) For i=0, . . . , μ−1, calculate κ(ιᵢ)←Hxor(κ(aᵢ),κ(bᵢ)) and

κ(t)←Hand(κ(t),κ(ιᵢ)). Herein, the circuit is denoted as κ(t)←<I. equ(ã,\tilde{b}).

Third, a secure signed integer addition circuit (I.add) is designed: Two ciphertexts ã and \tilde{b} having a length of μ bits and storing signed integers msg(ã) and msg(\tilde{b}) are given. UI.add outputs two ciphertexts, namely, ñ and κ(ƒ) that respectively store an addition result and an error/overflow information. UI.add is directly used during the construction, only a ciphertext having a length of μ bits is output, and a carry-out is discarded.

Step 1. when the two's complement number system is used, perform UI.add addition to add two numbers and reserve μ bits, that is, ñ*←UI.add(ã,\tilde{b}), and ñ=(κ(n*_{μ-1}), . . . ,κ(n*₀)) is recorded.

Step 2. indicate one error when either of the following two cases occurs:

(1) two positive numbers produce a negative addition result

(a_{μ-1}=0,b_{μ-1}=0,n_{μ-1}=1) and

(2) two negative numbers produce a positive addition result

(a_{μ-1}=1,b_{μ-1}=1,n_{μ-1}=0), where an SLWE instance κ(ƒ) is used to store overflow information, that is, ƒ₀=(1⊕a_{μ-1}⊕b_{μ-1})Λ(b_{μ-1}⊕n_{μ-1}) such that the overflow occurs when ƒ₀=1; otherwise, ƒ₀=0. Step 2 proceeds as follows:
κ(ƒ)←Hand(Hxnor(a_{μ-1},b_{μ-1}), Hxor(b_{μ-1},n_{μ-1})) . . . Herein, the circuit is denoted as (ñ,κ(ƒ))←I.add(ã;\tilde{c}₀).

Fourth, a secure signed integer comparison circuit (I.cmp) is designed: Two ciphertexts ã and \tilde{b} having a length of μ bits are given, and I.cmp outputs an encrypted bit κ(n). A concept thereof is as follows: If sign bits are different, an integer with a positive sign bit is selected as a relatively large integer. Otherwise, two integers are compared directly by using UI.cmp and a result is output. I.cmp includes the following steps:

Step 1: calculate κ(d)←UI.cmp(ã,\tilde{b}).

Step 2: herein, if two sign bits of the input are different (in other words, (a_{μ-1},⊕b_{μ-1}=1)), select a plaintext of final output as n=a_{μ-1}; otherwise, select the plaintext of the final output as n=d. Construction is performed as follows: t=Hxor(κ(a_{μ-1}),κ(b_{μ-1}); c₁=Hand(κ(a_{μ-1})t); and c₂=Hand(κ(d),Hnot(t)), and κ(n)←Hxor(c₁,c₂). Fifth, secure integer obvious selection is designed: Two ciphertexts ã and \tilde{b} having a length of μ bits and an encrypted bit κ(s) are input, and ñ is output. If s=1, sg( [symbol] )=msg( [symbol] ). If s=0, msg( [symbol] )=msg( [symbol] ). A construction procedure is as follows: For i=0, . . . , μ−1, calculating

κ(cᵢ)←Hand(κ(aᵢ),κ(s)),κ(c′ᵢ)←Hand(κ(bᵢ),κ(s)), and κ(nᵢ)←Hand(κ(cᵢ),κ(c′ᵢ)). Herein, the algorithm is denoted as ñ←I.obv(ã,\tilde{b},κ(s)).

Sixth, secure multi-integer obvious selection (I.mobv) is designed: z encrypted unsigned integer values ã₀, . . . , ã_{z-1} having a length of μ bits and z encrypted bits κ(s₀), . . . ,κ(s_{z-1}) are input, and ñ is output. If sᵢ=1, msg(ñ)=msg(ãᵢ). Only one of s₀, . . . ,s_{z-1} is equal to 1 and remaining numbers are equal to 0. The algorithm is constructed as follows:

ñ is initialized as a ciphertext which encrypts 0 having a length of μ bits. For i=0, . . . ,z−1 and j=0, . . . ,μ−1 , κ(e_{i,j})←Hand(κ(a_{i,j}),κ(sᵢ)) and κ(nⱼ)←Hxor(κ(nⱼ),κ(e_{i,j})) are calculated, where ãᵢ=κ(a_{i,μ-1}), . . . ,κ(a_{i,0})). Finally, ñ=(κ(n_{μ-1}), . . . ,κ(n₀)) is output, and the circuit is denoted as ñ←I.mobv(ã₀, . . . ,ã_{z-1};κ(s₀), . . . ,κ(s_{z-1})).

Based on I.cmp and I.obv, two new circuits are designed: a secure maximum number selection (I.maxe) circuit and a secure maximum tuple selection (I.maxt) circuit. Then constructions of the two protocols are separately provided.

A construction of I.maxe: ã and \tilde{b} having a length of μ bits are used as input, and I.maxe outputs ñ. If msg(ã)≥msg(\tilde{b}), msg(ñ)=msg(ã); otherwise, msg(ã)=msg(\tilde{b}). It may be obtained as follows:

t→I.cmp(ã,\tilde{b}) and ñ←I.obv(ã,\tilde{b},t).

A construction of I.maxe: Two tuples (ã,\tilde{d}ₐ) and (\tilde{b},\tilde{d}_{b}) having a length of μ bits are used as input, I.maxe outputs (ñ,\tilde{d}ₙ), a plaintext value of ñ is equal to a larger one of ã and \tilde{b}, but \tilde{d}ₙ∈{\tilde{d}ₐ,\tilde{d}_{b}} is a corresponding identical equation of n%, and it may be obtained as follows:

t→I.cmp(ã,\tilde{b}),ñ←I.obv(ã,\tilde{b},t), and \tilde{d}ₙ←I.obv(\tilde{d}ₐ,\tilde{d}_{b},t).

Seventh, a secure signed integer multiplication circuit (I.mul) is designed: Two ciphertexts ã and \tilde{b} having a length of μ bits are given, and a ciphertext ñ including a 2μ SLWE instance is output as a storage result.

Step 1: same as step 1 of UI.mul.

Step 2: invert a plaintext bit of κ(c_{i,i+μ-1}) in \tilde{c}ᵢ(i=0, . . . ,μ−2), in other words, for i=0, . . . ,μ−2, calculate κ(c_{i,i+μ-1})←Hnot(κ(c_{i,i+μ-1})). For [symbol] _{μ-1}, plaintext bits stored from a location μ−1 to a location 2μ−3 need to be inverted. In other words, for j=μ−1, . . . ,2μ−3, κ(c_{μ-1,j})←Hnot(κ(cᵤ₋₁ⱼ)) is calculated. Then, all \tilde{c}′ᵢ are added together through integration to obtain ñ. That is,

(1) Initialize ñ as a length of μ+1 bits, where for j=0, . . . ,μ−1;κ(n_{μ})=κ(0).

(2) For i=1, . . . ,μ−1, calculate ñ←UI.add(ñ,\tilde{c}*ᵢ) After I.add is executed μ times, ñ←UI.add(ñ,\tilde{v}) is calculated. For j=0, . . . ,μ−2;j≠μ, κ(v_{2μ-1})=κ(v_{μ})=κ(1), and κ(vⱼ)=κ(0). Finally, relatively low 2μ bits in ñ are used as a final result, and the circuit is denoted as ñ←I.mul(ã,\tilde{b}).

4. Secure computation with multi-key is designed, and all secure unsigned/signed integer circuits constructed above can only be calculated with a same key. If calculation needs to be performed across different domains/keys, POCNet cannot be directly applied. A simple solution is to use a multi-key fully homomorphic encryption (MKFHE) scheme to construct a circuit. However, an existing MKFHE scheme is still inefficient compared to the TFHE in terms of storage requirements and computational overheads. Another solution is to use a bootstrap and a transformation key is used to map one encrypted domain to another encrypted domain. Since the bootstrap is remarkably effective in POCNet, the second method is used to achieve secure multi-key calculation.

To construct a secure computations layer in POCNet, all ciphertexts are transferred to a same encrypted domain σ for secure computation, that is, a DU j′ data domain is transformed into a σ data domain by using BK_{sj→σ}and a CSP m′ s data domain is transformed into a σ data domain by using BKₛ_{ₘ}_{→σ}. After the computation is completed, for decryption, a CP uses BK_{σ→s}_{_{b}} to transform a final result to an authorized user b. Since a transformation key acts as a public key, the bootstrap may be stored and executed at the CP without compromising privacy of a DU/CSP.

Since a parameter used in a CNN is usually a non-integer, the parameter cannot be directly used by a constructed signed integer circuit. To store the non-integer value, the non-integer value needs to be converted into a fixed-point number, denoted as msg(ã)·2^{x} and (ã,2^{x}), and a ciphertext is ã=( [symbol] _{μ-1}, . . . , [symbol] ₀). It is noted that information of msg(ã) is not leaked when x is learned. For example, 0.25 may be denoted as 4×2⁻⁴, and stored as (\tilde{c},−4), where \tilde{c} stores an integer 4. When ã and \tilde{c} are not decrypted, it is very difficult for others to determine (ã,−2) and (\tilde{c},−2).

In this example, a lowercase letter and a hat ã are used to denote a fixed-point ciphertext, and an uppercase letter Â is used to denote an encrypted matrix. The latter stores an encrypted fixed-point number â_{i,j} (that is, a Scale-invariant LWE (SLWE) instance having a length of μ bits and an integer number) in each element, and i and j are limited by a size of the encrypted matrix.

In this example, secure data transformation (DT):ã=(ã, x) and y are given, where ã is a ciphertext having a length of μ bits, a goal of DT is to control a plaintext length value of ã and to produce a new ciphertext \hat{n}=(\hat{n},z), such that msg(ã×2^{x})≈msg(ñ)×2^{z} (x≤z). ñ in the latter is a ciphertext having a length of μ bits, and a non-integer is converted into a fixed-point number, thereby implementing calculation of the non-integer. The construction is performed as follows: It is set that n_{μ-1}=. . . =n_{μ-1+x-z}= [symbol] _{μ-1} and n_{j+x-z}= [symbol] ⱼ(j=μ−2, . . . ,z−x), and the circuit in this case is denoted as \hat{n}←DT(â,z).

Secure ciphertext length control (CLC): CLC is used to securely control a length of a ciphertext, that is, ã is set to (ã,x) having a length of μ bits, to obtain a new ciphertext (ñ,z) of μ′−length ñ, such that msg(ã)×2^{x}≈msg(ñ)×2^{z}(μ≥μ′). Construction is performed as follows: It is set nⱼ= [symbol] _{μ-μ′+j}(j=μ′−1, . . . ,0) and z=x+μ−μ′. Herein, the circuit is denoted as (ñ,z)←CLC(â,x),μ−μ′.

It is noted that a difference between DT and CLC is that ciphertexts of both input and output during DT are the same, while ciphertexts of both input and output during CLC may be different.

Secure data uniform transformation (Uni):âₐ₋₁=(ãₐ₋₁,xₐ₋₁), âₐ₋₂=(ãₐ₋₂,xₐ₋₂), âₐ₋₃=(ãₐ₋₃,xₐ₋₃) is input, and Uni outputs \hat{n}ₐ₋₁=(ñₐ₋₁,z)\hat{n}ₐ₋₂=(ñₐ₋₂,z),\hat{n}ₐ₋₃=(ñₐ₋₃,z) such that msg(ñⱼ)×2^{x}=msg(ãⱼ)×2^{z}. Construction is performed as follows:

(1) Calculate z=min(xₐ₋₁, . . . ,x₀).

For j=0, . . . , a−1, calculate (ñⱼ,z)←DT((ãⱼ,xⱼ), z).

Based on Uni and secure integer computation, the following commonly used secure fixed-point calculation may be implemented:

Secure fixed-point number addition (F.add):â=(ã, x) and \hat{b}=(\tilde{b},y) are given, and a goal of F.add is to calculate \hat{n}=(ñ,z), such that

msg(ñ×2^{z})=msg(ã)×2^{x}+msg(\tilde{b})×2^{y}. Construction is performed is as follows:

Step 1: execute \hat{b}*=(\tilde{b}*,z).

Step 2: calculate ñ←I.add(ã*,\tilde{b}*) and output (ñ,z).

A construction of a secure fixed-point number comparison circuit (F.cmp), a construction of a secure fixed-point number maximum selection circuit (F. maxe), and a construction of a secure fixed-point tuple maximum selection circuit (F. maxe) are similar to that of the F.add circuit. A difference lies in that in step 2 of F.add, I.add is correspondingly replaced with the secure integer circuits I.cmp, I.maxe, and I.maxt separately. Adding is performed separately. Next, secure fixed-point multiplication is constructed.

Secure fixed-point number multiplication (F.mul):â=(ã,x) and \hat{b}=(\tilde{b},y) are given, and a goal of F.mul is to securely calculate a fixed-point result \hat{n}=(ñ,z), such that msg(ñ)×2^{z}=msg(ã)×msg(\tilde{b})×2^{x+y}. Construction is performed is as follows:

Step 1: calculate \hat{n}←I.mul(ã,\tilde{b}).

Step 2: calculate (ñ,z)←CLC((ñ,x+y),2μ−μ′). After the calculation is completed, F.mul outputs (ñ,z).

Remark 1: DT, CLC, and Uni need only a data copy operation and do not need any arithmetic calculation. Therefore, the above two operations do not incur any computational cost at the CP.

Remark 2: To uniform the ciphertexts, both DT and CLC can be used for fixed-point number approximation. Both the circuits may cause some precision losses but can save significant computational and storage costs.

In this example, a convolution layer.

To enable a general technician to better understand the technical solutions of the present invention, the following describes the present invention in detail below with reference to the accompanying drawings.

A matrix X having a size of w₁×h₁×d₁ and each filter matrix w having a size of s×s×d₁ are given, and a ciphertext CONV outputs a matrix Y having a size of w₂×h₂×d₂, where w₂=(w₁−s +2p)/e+1,h₂=(h₁−s+2p)/e+1, and p is a zero padding amount on a border, and e a size of a filter sliding step. Mathematically, Y is calculated based on the following formula:

$${y}_{i , j , k} = {\sum }_{γ = 0}^{{d}_{i} - 1} {\sum }_{α = 0}^{s - 1} {\sum }_{β = 0}^{s - 1} {u}_{α , β , γ , k} \cdot {x}_{ai + α , aj + β , γ} .$$

It is set that w₁=h₁, to obtain w₂=h₂. Before construction, calculation of two fixed-point matrixes is described and introduced.

Secure fixed-point matrix addition (F.madd): Two encrypted matrixes \hat{X} and Ŷ having a size of a×b are input, and F.madd outputs matrixes Ĉ having a same size. An execution process is as follows: For 0≤i<a and 0≤i<b, calculate ĉ_{i,j}←F.add(ĉ_{i,j},â_{i,j}). Secure fixed-point convolutional computation (F.conv): An encrypted matrix Xᵢ having a size of w₁×w₁ and an encrypted filter matrix Û having a size of s×s are input, and F.conv outputs an encrypted matrix of having a size of w₂×w₂ by using the following program: For 0≤i<w₂, 0≤j<w₂, 0≤a<s−1, and 0≤b<s−1, calculate â_{a,b,i,j}←F. mul(û_{a,b},\hat{x}_{ei+a,ej+b}) and

ĉ_{i,j}←F.add(ĉ_{i,j},â_{a,b,i,j}).

An architecture of a SCONV layer: d₁ encrypted matrixes \hat{X}ᵢ and a matrix Û_{i,j} having a size of d₁×d₂ are input, and a SCONV layer outputs d₂ encrypted matrixes Ŷⱼ. The architecture is as follows:

(1) Initialize each element in Ŷⱼ, and set an encrypted value to 0.

(2) For i=0, . . . ,d₁−1,j=0, . . . ,d₂−1, calculate \hat{X}′_{i,j}←F. conv(\hat{X}ᵢ,Û_{i,j}) and Ŷ′_{i,j}←F.madd(Ŷᵢ,\hat{X}′_{i,j}).

In this example, a pooling layer is specifically as follows: Max-pooling is used as a pool, and a w₁×w₁ encrypted matrix is input, and an w₂×w₂ encrypted matrix is output. Because a secure extreme value function is used, each block of t×t is reduced to a single encrypted value, where in w₂ =(w₁−t+2p)/e+1, p is padding, t is a size of a filter, and e is a step (for example, w₁=4,t=2,p=0,e=2,w₂=2). Herein, F.maxe is used to construct a secure maximum pooling protocol, and then a secure pooling layer is constructed by using the secure maximum pooling protocol. A t×t encrypted matrix \hat{X} is given, each encrypted fixed-point number \hat{x}_{i,j}(0≤i,j≤t−1) is an encrypted fixed-point number \hat{x}* output by F.pool, and \hat{x}* has a maximum plaintext value from the t² encrypted elements.
(i) X_{i,j}(0≤i,j≤t−1) is inserted into a set Θ. They are denoted as \hat{x}′₀, . . . ,\hat{x}′ₜ_{²}₋₁, where s(Θ) denotes a size of the set Θ.
(ii) The following program is repeated, until the set Θ has only one element. In other words, if s(Θ)=1, the element is used as a finally output \hat{x}*. Therefore, the algorithm is executed as follows:

If a size of s(Θ) is mod2=0 and s(Θ)>1, for i=0 to s(Θ)/2−1,\hat{x}*←F.maxe(\hat{x}′₂ᵢ;\hat{x}′₂ᵢ₊₁) is calculated, [symbol] *₀,L, [symbol] _{(S(Θ)-1)/2-1} is inserted into the set Θ, and it is set that Θ←Θ′.

If a size of s(Θ) is mod2≠0 and s(Θ)>1, for i=0 to (s(Θ)−1)/2−1,\hat{x}* ←F.maxe(\hat{x}′₂ᵢ;\hat{x}′₂ᵢ₊₁) is calculated. [symbol] *₀,L, [symbol] _{(S(Θ)-1)/2-1} is inserted into a set Θ′, and it is set that Θ←Θ′.

The secure pooling layer is implemented as follows: To construct the secure pooling layer, a w₁×w₁ encrypted matrix \hat{X} is input and output is obtained (that is, an w₂×w₂encrypted matrix Ŷ). The following steps are performed: for 0≤i≤w₂−1 and 0≤j≤w₂1,
(i) constructing each encrypted matrix [symbol] _{i,j} having a size of t×t , where for [symbol] _{i,j,a,b}= [symbol] _{ei+a,ej+b}, 0≤a≤t−1,0≤b≤t−1, and e is a step; and
(ii) executing [symbol] _{i,j}←F.pool( [symbol] _{i,j}), where after the calculation is performed, ŷ_{i,j} is used as an element of Ŷ.

In this example, an ReLU function is specifically as follows: A t×t encrypted matrix \hat{X} is given, and a goal of an SReLU is to produce a t×t encrypted matrix Ŷ, such that msg(ŷ_{i,j})←ReLU(msg(\hat{x}_{x,j}))=max(0,msg(\hat{x}_{i,j})). To implement the SReLU, a simplest method is to securely calculate the ReLU function element by element. As an encrypted fixed-point number, [symbol] ₀ stores an integer of 0.

In this example, a fully-connected layer is specifically a secure fixed-point inner product circuit (F.inp): Two encrypted vectors \hat{X}=(\hat{x}₀, . . . ,\hat{x}ₐ₋₁) and Ŷ=(ŷ₀, . . . ,ŷₐ₋₁) are given, and F.inp outputs \hat{n}, where

$$msg ( {\hat{n}}_{i} ) = {\sum }_{j = 0}^{n - 1} msg ( {\hat{x}}_{j} ) \cdot msg ( {\hat{y}}_{j} ) .$$

Then construction is performed as follows: ñF.mul(\hat{x}₀,ŷ₀). For j=1, . . . ,a−1,\tilde{t}ⱼ←F.mul(\hat{x}ⱼ,ŷⱼ) and \tilde{f}←F.add(ŷ,\hat{t}ⱼ) are calculated.

The fully-connected layer (SFC) is implemented as follows: Encrypted vectors \hat{X}=(\hat{x}₀, . . . ,\hat{x}ₐ₋₁) and Ŷᵢ =(ŷ_{i,0}, . . . ,ŷ_{i,a-1})(0≤i≤b−1) are input, and the secure fully-connected layer outputs \hat{N}=(\hat{n}₀, . . . ,\hat{n}_{b-1}), where

$$msg ( {\hat{n}}_{i} ) = {\sum }_{j = 0}^{n - 1} msg ( {\hat{x}}_{j} ) \cdot msg ( {\hat{y}}_{i , j} ) .$$

The SFC is run as follows: For i=0, . . . ,b−1, calculate ñᵢ←F.inp(\hat{X},Ŷᵢ).

In this example, secure Softmax regression needs to be used in conjunction with the secure fully-connected layer to achieve multi-class classification. For a plaintext version (x₀,d₀), . . . ,(xₜ₋₁,dₜ₋₁) of a softmax layer with input, a softmax function first produces y=(y₀, . . . ,yₜ₋₁), where

$${y}_{i} = \frac{{e}^{{x}_{i}}}{{\sum }_{j = 0}^{t - 1} {e}^{{x}_{j}}} ( i = 0 , ⋯ , t - 1 ) ,$$

for all 0≤j<k and j≠a, if yₐ>yⱼ, a finally output unit is dₐ. Since an SSOFT needs to output a ciphertext label, and e^{x} is a monotonically increasing function, only a maximum xₘₐₓ needs to be found by using (x₀, . . . ,xₜ₋₁) and a corresponding dₘₐₓ is output. The above construction is performed as follows:

An SSOFT layer is implemented as follows: t encrypted tuples (\hat{x}₀,\hat{d}₀), . . . , \hat{x}ₜ₋₁,\hat{d}ₜ₋₁) are given; and the SSOFT finally outputs an encrypted identity \hat{d}*. Construction is performed as follows:

pᵢ is inserted into Θ, where S(Θ) denotes a size of the set Θ.

This process is similar to an F.pool architecture, except that F.maxe is replaced with F.maxt.

After the calculation is completed, only one tuple (\hat{x}*₀,\hat{d}*₀) is left in Θ, and the encrypted identity that is finally output is denoted as \hat{d}=\tilde{d}*₀.

In this example, the user-defined non-linear activation function is preferably implemented. During calculation of the non-linear function, a function structure is also preserved.

Details are as follows:

Privacy-preserving piecewise polynomial calculation protocol: A ciphertext \hat{x}₀ and an encrypted piecewise function f(x)=fᵢ(x) (if pᵢ≤x<pᵢ₋₁) are given, where fᵢ(x)=a_{i,k-1}x^{k-1} +. . . +a_{i,1}x+a_{i,0}, 0≤i≤z , and k≥1 (all fixed-point coefficients a_{i,k-1}, . . . , a_{i,0} (stored as ã_{i,k-1}, . . . , ã_{i,0}), and piecewise intervals and pᵢ₋₁ are encrypted (stored as \hat{p}ᵢ₋₁, . . . ,\hat{p}_{i,0}). A goal of the privacy-preserving piecewise polynomial calculation protocol is for secure computation and encryption f(msg(\hat{x}₀)). Details are as follows:

Step 1: calculate an encrypted value of x x², . . . , x^{k-1}, where it is set that \hat{t}₁=\hat{x}₀. If k>2, for j=2, . . . ,k−1, calculate \hat{t}ⱼ←F.mul(\hat{x}₀,\hat{t}ⱼ₋₁). Before Uni is executed, if k=1, for i=0, . . . ,z−1, it is set that ŷᵢ=â_{i,0}, and skip to step 3 for processing. Otherwise, step 2 is performed.

Step 2: output encryption fᵢ (x) that is denoted as ŷᵢ. Construction thereof is performed as follows: For i=0, . . . , z−1, record that ŷᵢ=â_{i,0}; then for i=0, . . . ,z−1 and j=1, . . . ,k−1, calculate ĝ_{i,j}←F.mul(\hat{t}ⱼ,â_{i,j}) and ŷᵢ←F·add(ŷᵢ,ĝ_{i,j}).

Step 3: normalize all encrypted fixed-point numbers to same precision, and calculate (ŷ′₀, . . . ,ŷ′_{z-1})←Uni(ŷ₀, . . . ,ŷ_{z-1}), where for i=0, . . . ,z−1,ŷ′ᵢ=(\tilde{y}′,c).

Step 4: securely compare x and a relationship between piecewise intervals and pᵢ₋₁ and pᵢ, that is,

(1) for i₁=−1, . . . ,z−1, calculating ℑᵢ_{₁}←F.cmp (\hat{x}₀,\hat{p}ᵢ_{₁})_{;}

(2) for i₂=0, . . . ,z−2, calculating ℑ′ᵢ_{₂}←H.not(ℑᵢ_{₂});

(3) for i₃=0, . . . ,z−1 , calculating ℑ*ᵢ_{₃}←H.xnor(ℑ′ᵢ_{₃},ℑᵢ_{₃}₋₁). Note: For ℑ*₀, . . . ,ℑ*_{z-1}, only one plaintext is equal to 1, and others are equal to 0.

Step 5: use encrypted bits ℑ*₀, . . . ,ℑ*_{z-1}, and select an encrypted value from \tilde{y}′₀, . . . ,\tilde{y}′_{z-1} by calculating \tilde{f}←I. movb(\tilde{y}′₀, . . . ,\tilde{y}′_{z-1};ℑ*₀, . . . ,ℑ*_{z-1}); finally, output \hat{f}=(\tilde{f},c), where \tilde{f}=(f_{μ-1}, . . . ,f₀).

Implement function privacy: Our privacy-preserving piecewise polynomial calculation protocol ensures privacy of user data and a user-defined function structure by performing the following setting: (1) Quantities of subfunctions used in a piecewise polynomial are the same for piecewise functions of all users. 2) Subfunctions of all the users share a same degree k.

The afore-mentioned are only preferred examples of the present invention, and all equivalent changes and modifications made in accordance with the claims of the present invention shall fall within the scope of the present invention.

What is claimed is:

1. A preservation system for preserving privacy of outsourced data in a cloud based on a deep convolutional neural network (CNN), wherein the system comprises a key generation center, a cloud platform, a data user, and a CNN service providing unit; the key generation center is an entity trusted by all other entities in the system, and is responsible for distributing and managing all keys of a data user or a CNN service provider, and all boot keys of the cloud platform; the cloud platform stores and manages encrypted data outsourced from a registrant in the system, and provides a computing capability to perform a homomorphic operation on the encrypted data; the CNN service provider provides a required deep CNN classification model for the data user, and a decision result reflects a current situation of the data user.

2. The preservation method for preserving privacy of outsourced data in a cloud based on a deep CNN according to claim 1, comprising the following steps:
step S1: transferring, by the data user, the encrypted data to the CNN service providing unit by using the cloud platform; and
step S2: after processing the encrypted data, outputting, by the CNN service providing unit, a ciphertext result and storing the ciphertext result on the cloud platform.

3. The preservation method for preserving privacy of outsourced data in a cloud based on a deep CNN according to claim 2, wherein step S2 is specifically as follows:
step S21: converting a format of the encrypted data, to obtain converted encrypted data;
step S22: processing the converted encrypted data sequentially by using a convolutional layer, a pooling layer, and an ReLU function of the CNN; and
step S23: executing full connection calculation and activation function calculation of the CNN, and outputting the ciphertext result.

4. The preservation method for preserving privacy of outsourced data in a cloud based on a deep CNN according to claim 3, wherein the format conversion comprises secure data transformation, secure ciphertext length control, and unified conversion of secure data.

5. The preservation method for preserving privacy of outsourced data in a cloud based on a deep CNN according to claim 3, wherein the convolutional layer specifically inputs d₁ encrypted matrixes \hat{X}ᵢ and a matrix Û_{i,j} having a size of d₁×d₂ , the convolutional layer outputs d₂ encrypted matrixes Ŷⱼ, and an architecture is as follows:
(1) initializing each element in Ŷⱼ by encrypting 0; and
(2) for i=0, . . . ,d₁₋₁,j=0, . . . ,d₂−1, calculating \hat{X}′_{i,j}←F.conv(\hat{X}ᵢ,Û_{i,j}) and Ŷ′ⱼ←F.madd(Ŷⱼ,\hat{X}′_{i,j}).

6. The preservation method for preserving privacy of outsourced data in a cloud based on a deep CNN according to claim 3, wherein the pooling layer specifically inputs a w₁×w₁ encrypted matrix \hat{X} and obtains output (that is, a w₂×w₂encrypted matrix Ŷ), and performs the following steps: for 0≤i≤w₂−1 and 0≤j≤w₂−1,
(i) constructing each encrypted matrix [symbol] _{i,j} having a size of t×t, wherein for [symbol] _{i,j,a,b}= [symbol] _{ei+a,ej+b}, 0≤a≤t −1, 0≤b≤t−1, and e is a step; and
(ii) executing ŷ_{i,j}←F.pool(Ĉ_{i,j}), wherein after the calculation is performed, [symbol] _{i,j} is used as an element of Ŷ.

7. The preservation method for preserving privacy of outsourced data in a cloud based on a deep CNN according to claim 3, wherein for the ReLU function, a t×t encrypted matrix \hat{X} is specifically given, and a goal of an SReLU is to produce a t×t encrypted matrix Ŷ, such that msg(ŷ_{i,j})←ReLU(msg(\hat{x}_{x,j}))=max(0, msg(\hat{x}_{i,j})).

8. The preservation method for preserving privacy of outsourced data in a cloud based on a deep CNN according to claim 3, wherein the full connection calculation of the CNN is specifically as follows:
inputting encrypted vectors [symbol] =( [symbol] ₀,L, [symbol] ₐ₋₁) and [symbol] =( [symbol] _{i,0},L, [symbol] _{i,a-1})0≤i≤b−1), and outputting, by a secure fully connected layer, [symbol] =( [symbol] ₀,L, [symbol] _{b-1}), wherein msg(\hat{n}ⱼ)=Σⱼ₌₀^{a-1}msg(\hat{x}ⱼ)·msg(ŷ_{i,j}); and for i=0, . . . ,b−1, calculating [symbol] ←F.inp( [symbol] , [symbol] ᵢ).

9. The preservation method for preserving privacy of outsourced data in a cloud based on a deep CNN according to claim 3, wherein the activation function calculation of the CNN is specifically as follows: giving t encrypted tuples ( [symbol] ₀, [symbol] ₀),L,( [symbol] ₜ₋₁, [symbol] ₜ₋₁); and finally outputting, by an SSOFT, an encrypted identity \hat{d}*, wherein construction is performed as follows:
(1) pᵢ is inserted into Θ, wherein s(Θ) denotes a size of the set Θ; and
(2) this process is similar to an F.pool architecture, except that F.maxe is replaced with F.maxt;
wherein after the calculation is completed, only one tuple ( [symbol] *₀, [symbol] *₀) is left in Θ, and the encrypted identity that is finally output is denoted as \hat{d}*=\hat{d}*₀.
